(19) United States
(12) Patent Application Publication
(10) Pub. No.: US 2021/0256637 A1
(43) Pub. Date: Aug. 19, 2021

(54) Systems and Methods for Travel Planning

(71) Applicant: Virtuoso, Ltd., Fort Worht, TX (US)

(72) Inventor: James Bendt, Excelsior, MN (US)

(21) Appl. No.: 16/791,621

(22) Filed: Feb. 14, 2020

(51) Int. Cl. G06Q 50/14; G06Q 10/02

(52) U.S. Cl. CPC G06Q 50/14; G06Q 10/025

(57) ABSTRACT

A method for travel planning may comprise the steps of displaying a plurality of travel interests on a user device associated with a travel planning platform; receiving a first input to the travel planning platform, the first input indicating one or more personal travel interests of a client, the one or more personal travel interests selected by the client from the plurality of travel interests; receiving a second input to the travel planning platform, the second input indicating a ranking by preference of the selected personal travel interests of the client; and the travel planning platform automatically forecasting average cost per person per day based on at least the first input for one or more of three-, four-, or five-star experiences.

The present disclosure relates to systems and methods for travel planning. More particularly, the present disclosure relates to systems and methods associated with a travel planning platform adapted to receive information regarding the personal travel interests of at least one client and then, inter alia, automatically generate a variety of outputs to effectuate efficiency in travel planning.

### BACKGROUND

Vacation planning is conventionally a long and cumbersome process. Travel advisors and/or their clients may spend countless hours and energy researching an array of travel interests relating to one or more prospective travel destinations, each destination having its own set of unique experiences. This planning process may become even more arduous when clients are operating under a specified budget, or seeking to coordinate travel with one or more travel companions.

### SUMMARY

The present disclosure generally relates to systems and methods for travel planning.

In an implementation, the method may comprise the steps of displaying a plurality of travel interests on a user device associated with a travel planning platform; receiving a first input to the travel planning platform, the first input indicating one or more personal travel interests of a client, the one or more personal travel interests selected by the client from the plurality of travel interests; and the travel planning platform automatically forecasting average cost per person per day based on at least the first input for one or more of three-, four-, or five-star experiences.

In another implementation, the method may further comprise the step of receiving a second input to the travel planning platform, the second input indicating a ranking by preference of the selected personal travel interests of the client.

In another implementation, the method may further comprise the step of receiving a third input to the travel planning platform, the third input indicating one or more travel preferences of the client.

In another implementation, the method may further comprise the step of receiving a fourth input to the travel planning platform, the fourth input indicating one or more personal travel interests of a travel companion of the client, the one or more personal travel interests selected by the travel companion from the plurality of travel interests; and the travel planning platform automatically identifying one or more commonalities between the selected personal travel interests of the client and the selected personal travel interests of the travel companion.

In another implementation, the method may further comprise the step of the travel planning platform generating a client-based forecast for a travel advisor, the client-based forecast relating to a first travel revenue anticipated based on a multi-trip travel plan developed for the client.

The details of one or more implementations are set forth in the accompanying drawings and the description below. Other features, objects, and advantages of the implementations will be apparent from the description and drawings.

### BRIEF DESCRIPTION OF THE DRAWINGS

For a more complete understanding of this disclosure and its features, reference is now made to the following description, taken in conjunction with the accompanying drawings, in which:

FIG. 1 illustrates a schematic overview of a travel planning system according to the present disclosure;

FIG. 2 illustrates a flow diagram of an implementation of a method of travel planning according to the present disclosure;

FIG. 3 illustrates an exemplary webpage associated with an implementation of the travel planning platform according to the present disclosure;

FIG. 4 illustrates an exemplary webpage associated with an implementation of the travel planning platform according to the present disclosure;

FIG. 5 illustrates an exemplary webpage associated with an implementation of the travel planning platform according to the present disclosure;

FIG. 6 illustrates an exemplary webpage associated with an implementation of the travel planning platform according to the present disclosure;

FIG. 7 illustrates a flow diagram of another implementation of a method of travel planning according to the present disclosure; and

FIG. 8 illustrates a flow diagram of yet another implementation of a method of travel planning according to the present disclosure.

Like reference symbols in the various drawings indicate like elements.

### DETAILED DESCRIPTION

Conventionally, vacation travel planning is a time- and research-intensive process, which requires balancing the personal travel interests of a client with the requirements, constraints, and/or preferences of the client (including scheduling requirements, budgetary constraints, travel preferences, and the like). On average, a traveler may visit at least thirty different websites and spend 20-30 hours to research, in piecemeal manner, destinations, experiences, availability, and costs associated with a single vacation. Vacation planning involving a group of travelers is even more complex, as one or two travelers typically develop the itinerary, which may or may not account for the travel interests of each member of the group. Due to the complexity and the multitude of variables inherent in this process, the number of trips that may be planned in a given year or over the course of a number of years may be limited. For clients, the net result may be fewer vacations over the course of their lifetime. For travel advisors, fewer planned vacations translates to reduced revenue.

Implementations of the present disclosure generally provide systems and methods for travel planning. More particularly, the present disclosure relates to a travel planning system comprising a travel planning platform, and methods of travel planning using the travel planning platform. In some implementations, the travel planning platform may be adapted to receive input relating to the personal travel interests of a client (and any travel companion(s)) and then, inter alia, automatically forecast travel costs per person per day for selected travel interests, and/or identify commonalities between the selected travel interests of the client and his/her travel companion(s), and/or automatically forecast—for the travel advisor—anticipated revenue relating to the selected travel interests of the client and any travel companion(s).

### Travel Planning System Overview

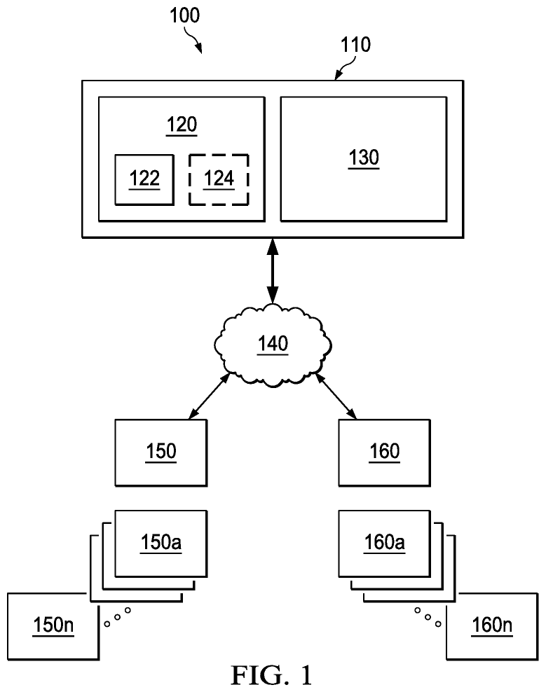

FIG. 1 depicts a schematic overview of an implementation of a travel planning system 100 according to the present disclosure. Travel planning system 100 may comprise a travel planning platform 110 residing on a server (not shown). The server may comprise a dedicated physical server or a cloud-based virtual server, as known and implemented by those of ordinary skill in the art.

The travel planning platform 110 may further comprise a processor configured to execute one or more computer program modules (not shown). The computer program modules may include one or more authentication modules, network modules, database or storage modules, communication modules, and/or any other modules known in the art.

With continued reference to FIG. 1, the travel planning platform 110 may comprise a client portal 120 through which a user, such as a client or a travel companion of the client, may access the travel planning platform 110. The travel planning platform 110 may further comprise an advisor portal 130 through which a travel advisor may access the travel planning platform 110. The travel planning system 100 may further comprise at least one user device 150 in communication with the travel planning platform 110 via a network 140, and at least one advisor device 160 in communication with the travel planning platform 110 via the network 140. The network 140 may comprise any combination of local area and/or wide area networks, using wired and/or wireless communication systems. For purposes of illustration, an implementation of the travel planning system 100 shown schematically in FIG. 1 includes a single user device 150 and a single advisor device 160. However, in other implementations, the system 100 may include one or more user devices 150a-n and one or more advisor devices 160a-n, all in communication with the travel planning platform 110 via the network 140.

In an implementation, a client may access the client portal 120 via user device 150 through a webpage, an application, or other means known in the art, each of which may be associated with the travel planning platform 110. Similarly, an advisor may access the advisor portal 130 via advisor device 160 through a webpage, application, or other means associated with the travel planning platform 110. In accordance with web and computer technology, as understood by one of ordinary skill in the art, user device 150 and advisor device 160 may include means for user input and means for displaying content generated by the travel planning platform 110. In some implementations, devices 150, 160 may comprise a desktop computer, a laptop computer, a mobile device such as a smart phone or tablet, or any other device having computing functionality, display functionality, and data communication capabilities operable to enable communication between the devices 150, 160 and the travel planning platform 110 via network 140.

With continued reference to FIG. 1, client portal 120 may further comprise a client dashboard 122, which may comprise a web interface through which the client may view and select personal travel interests from among a plurality of travel interests available on the travel planning platform 110. The client portal 120 may optionally also comprise a travel companion dashboard 124, through which one or more travel companions of a client may—upon invitation from the client—view and select their personal travel interests from among the plurality of travel interests on the travel planning platform 110. Once a client has selected his/her personal travel interests through the client dashboard 122, the client may return to the client portal 120 at any time to review, update, and/or modify these selections. The client may also view the selections of his/her travel companion(s) through the client portal 120.

Similarly, the advisor portal 130 may allow a travel advisor to view and/or edit client accounts, including selections relating to the personal travel interests of a given client and his/her travel companion(s), as well as a plurality of clients and their travel companions. The advisor portal 130 may also allow a travel advisor to review metrics and trends relating to the personal travel interests of a plurality of clients of the travel advisor. In some implementations, the advisor portal 130 may comprise a backend customer relationship management (CRM) tool, which may allow the travel advisor to design and manage a client's travel portfolio. For example, the travel advisor may view a client's account, update interests and preferences on behalf of the client, and publish the results (which may include, for example, budget forecasts, comparison charts, calendars, and maps showing future travels) for the client to review through his/her client portal 120. In addition, the CRM tool of the advisor portal 130 may include an automated messaging system that allows a travel advisor to set up client notifications about upcoming important dates (such as time to start planning a trip for an annual vacation or milestone event, or time to meet with the travel advisor for an annual review). The automated messaging system may further allow a travel advisor to set up client notifications with personalized travel suggestions based on the personal travel interests the client has previously selected from among the plurality of travel interests on the travel planning platform 110. The automated messaging system may transmit such client notifications via email, text message, notification on the client portal 120, or other electronic messaging means known in the art.

While the general framework components and functionality of the travel planning system 100 have been described, it is to be understood that the present disclosure is not to be so limited. As understood by one of ordinary skill in the art, the travel planning system 100 may be modified and configured in many different ways and may include numerous functionalities, including as described in more detail herein.

### Travel Planning Method

In accordance with the methods of the present disclosure, a client may access the client portal 120 of the travel planning platform 110 through his/her user device 150 by first registering an account with the travel planning platform 110. In response to verified account registration by the client, the travel planning platform 110 may transmit a unique link to the registered client via, e.g., email, text, or other electronic messaging means known in the art. The link may provide the client access to his/her personal client dashboard 122 on the client portal 120.

In other implementations, registration may not be required to gain access to the client portal 120. For example, the present disclosure may contemplate various means of accessing the client portal 120, including based on a subscription-based plan, a monthly plan, a fee-for-service plan, a free trial-basis plan, or any other means contemplated by those in the field of travel advisory.

In other implementations, a travel advisor may access the travel advisor portal 130 of the travel planning platform 110 by logging into his/her advisor account on his/her advisor device 160.

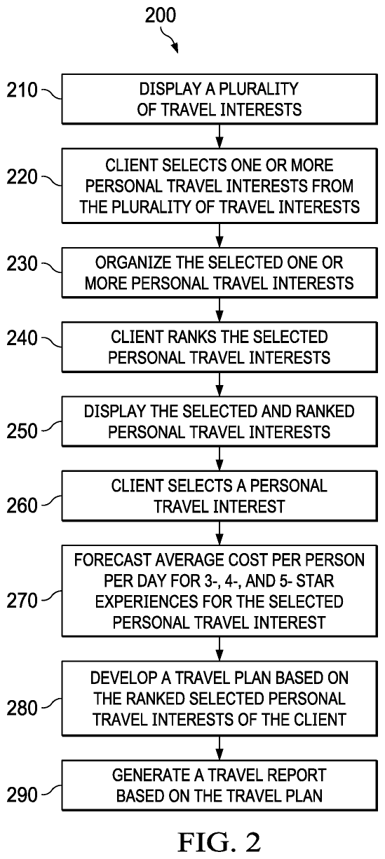

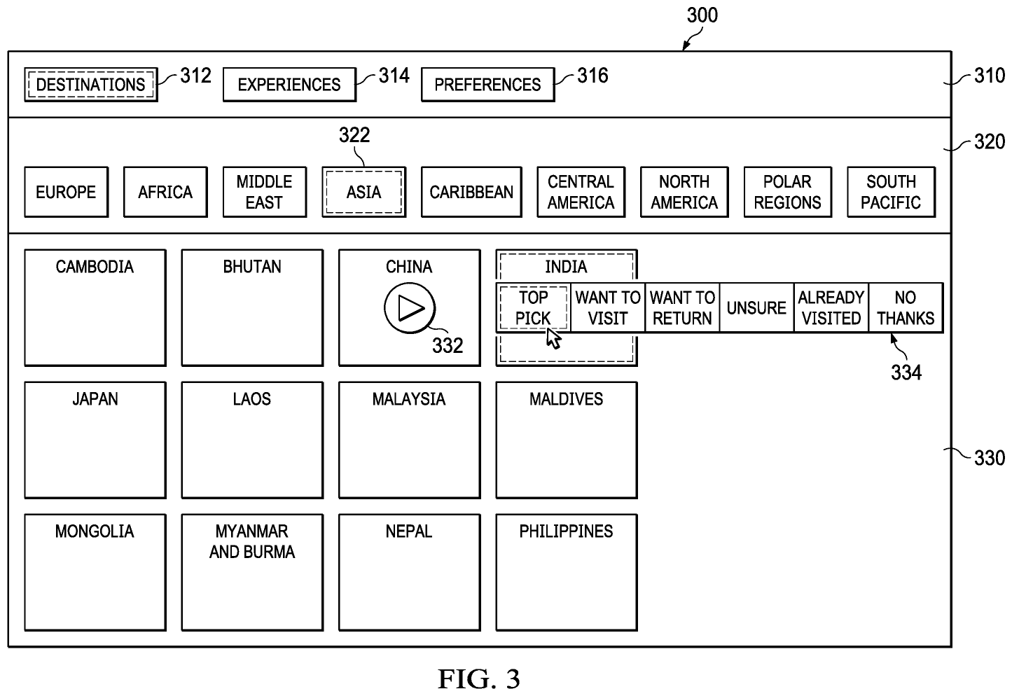

Reference is now made to FIG. 2, which depicts a flow diagram of an implementation of a method 200 of travel planning, and to FIG. 3, which depicts an exemplary webpage 300 associated with the method 200 described in FIG. 2, according to the present disclosure. In FIG. 2, after the client accesses his/her personal dashboard on the client portal, at step 210, the travel planning platform may display a plurality of travel interests, which may be viewed and selected by the client on the client's user device via a webpage 300 (shown in FIG. 3) associated with the travel planning platform. Referring now to FIG. 3, the displayed travel interests may comprise one or more selectable categories in a menu bar 310 including, by way of example, travel destinations 312 (such as cities, countries, and/or regions around the world); travel activities and experiences 314 (such as types of activities to be enjoyed during travel); and/or travel preferences 316 (such as styles of travel, styles of lodging, and other details relating to when and how the client desires to travel). Although the present disclosure will hereafter describe travel interests in the context of travel destinations, travel experiences, and travel preferences, it is to be understood that the disclosure is not intended to be so limited and may extend to any number of travel-related interests known or contemplated in the art. Additionally, the terms travel experiences and travel activities may be used interchangeably throughout the present disclosure.

Referring again to FIG. 2, at step 220, the client may curate his/her interests. The step of curating allows the client to select one or more personal travel interests from among the plurality of travel interests displayed by the travel planning platform. According to one implementation, the plurality of travel interests may be displayed and selected by destination. As shown in FIG. 3, when the “Destinations” category 312 is selected from menu bar 310 (the selection of “Destinations” 312 indicated by the shading of element 312), the webpage 300 may display a top-level menu bar 320 comprising a plurality of categories relating to destinations, such as continents or regions around the world. Examples of categories in the top-level menu bar 320 may include Europe, Africa, Middle East, Asia, Caribbean, Central America, North America, Polar Regions, South Pacific, etc. Each top-level menu destination from the top-level menu bar 320 may include a sub-level menu 330 listing more specific destinations. By way of example, and as shown in FIG. 3, a selection of “Asia” 322 from the top-level menu bar 320 may reveal a sub-level menu 330 listing countries within Asia, such as Cambodia, Bhutan, China, India, Japan, Laos, Malaysia, Maldives, Mongolia, Myanmar & Burma, Nepal, Philippines, etc. When the client chooses a particular destination from the sub-level menu 330, the travel planning platform may display informative summary content 332 (such as photographs, video, or the like) relating to the selected destination, thereby allowing the client an opportunity to learn more about the particular destination. By way of example, informative summary content element 332 on the “China” block within sub-level menu 330 indicates the availability of a video relating to China.

After reviewing one or more top-level menu 320 and sub-level menu 330 destinations, the client may select his/her personal travel interests from among the plurality of travel destinations. Personal travel interests by destination may be selected by assigning a rating, checking a box, or by another means indicating traveler interest. According to one implementation, and as shown in FIG. 3, a “rating” 334 may be assigned to one or more of the plurality of travel interests. Ratings may include, but are not limited to, “Top Pick” (indicating a high personal interest of the client); “Want to Visit” (indicating, for example, a second-tier personal interest); “Want to Return” (indicating, for example, a third-tier personal interest); “Unsure” (indicating potential or ambivalent interest); “Already Visited” (indicating some level of disinterest); and “Not Interested” (indicating absolute disinterest). The “Unsure” selection may serve as a default selection. The client may select, such as by mouse-clicking, a rating for each destination in the sub-level menu 330. The travel planning platform may save the client rating and/or selection. In an implementation, the client's personal travel interests may correspond to every sub-level menu destination assigned a “Top Pick,” “Want to Visit,” or “Want to Return” rating by the client. The client may, at any time, modify or update his/her selection of personal travel interests on the client dashboard.

While the step of selecting one or more personal travel interests from the plurality of travel interests has been described in connection with a top-level 320 and a sub-level menu listing 330, it is to be understood that the present disclosure is not intended to be so limited and a client may select his/her personal travel interests (including assigning a rating) from any manner of listings, categories, menus, or directories known in the art.

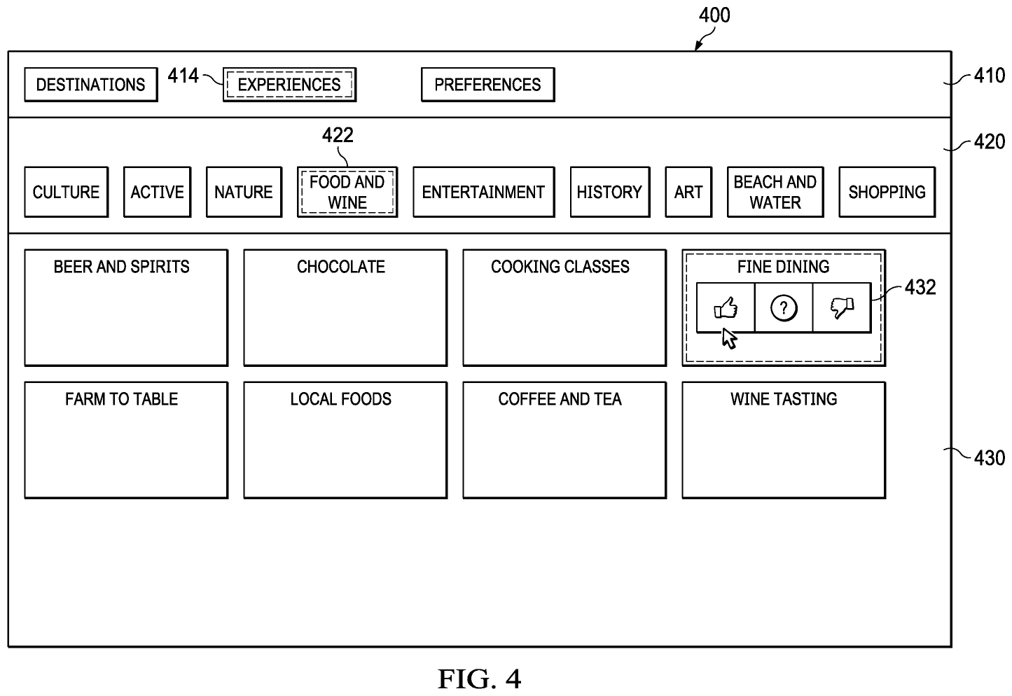

With continued reference to step 220 of FIG. 2, and with further reference to FIG. 4 (which depicts another exemplary webpage 400 associated with the method 200 described in FIG. 2), travel interests may also be based on travel experiences. As shown in FIG. 4, when the “Experiences” category 414 is selected from menu bar 410 (the selection of “Experiences” 414 indicated by the shading of element 414), the webpage 400 may display a top-level menu bar 420 comprising a plurality of categories relating to travel experiences. Examples of categories of experiences in the top-level menu bar 420 may include Culture; Active; Nature; Food and Wine; Entertainment; History; Art; Beach and Water; Shopping; etc. Upon selection of a category from the top-level menu bar 420, the travel planning platform may display a sub-level menu 430 listing an array of more specific experiences relating to the selected top-level menu item. For example, as shown in FIG. 4, if the client selects “Food and Wine” 422 from the top-level menu bar 420, a sub-level menu 430 may include a listing of experiences relating to food and wine, e.g., Beer and Spirits; Chocolate; Cooking Classes; Fine Dining; Farm to Table; Local Foods, Coffee and Tea; Wine Tastings; etc.

After reviewing one or more top-level menu 420 and sub-level menu 430 experiences, the client may select his/her personal travel interests from among the plurality of travel experiences by assigning a rating, checking a box, or other means indicating traveler interest. According to one implementation, and as shown in FIG. 4, a “rating” 432 may be assigned to one or more of the plurality of travel experiences. Ratings may include, but are not limited to, selections showing a thumbs up (indicating a personal interest of the client), a thumbs down (indicating disinterest), or a question mark/neutral sign (indicating potential or ambivalent interest). Ratings may also include “Top Pick” (indicating a high personal interest of the client); “Want to Visit” (indicating, for example, a second-tier personal interest); “Want to Return” (indicating, for example, a third-tier personal interest); “Unsure” (indicating potential or ambivalent interest); “Already Visited” (indicating some level of disinterest); and “Not Interested” (indicating absolute disinterest), as discussed in connection with rating 334 of FIG. 3.

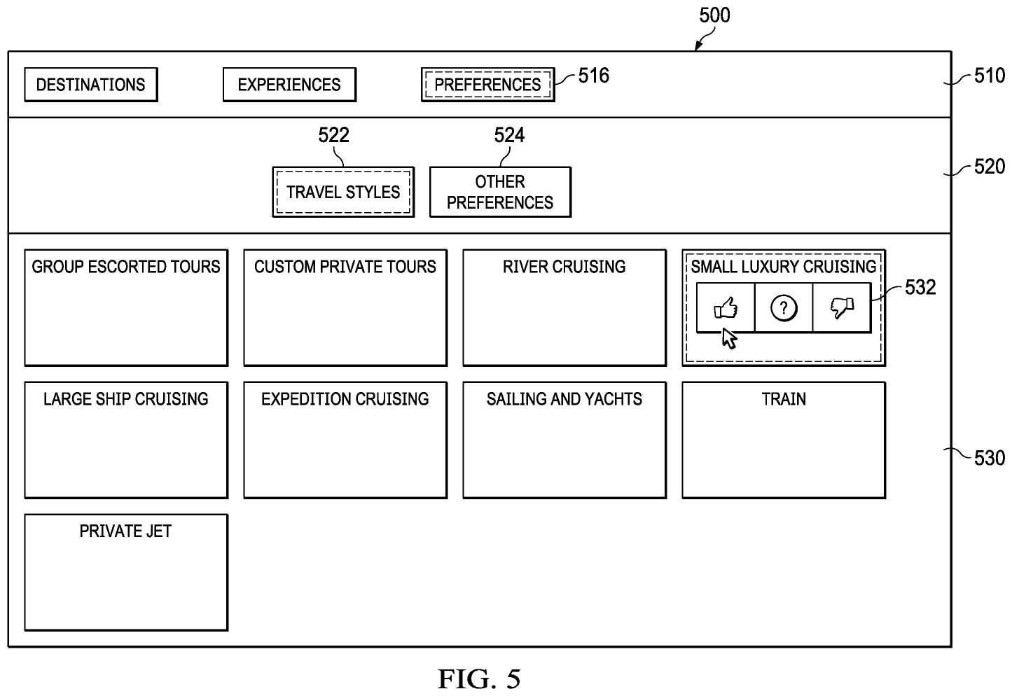

With continued reference to step 220 of FIG. 2, and with further reference to FIG. 5 (which depicts another exemplary webpage 500 associated with the method 200 described in FIG. 2), travel interests may further be based on travel preferences. As shown in FIG. 5, when the “Preferences” category 516 is selected from menu bar 510 (the selection of “Preferences” 516 indicated by the shading of element 516), the webpage 500 may display a top-level menu bar 520 comprising one or more categories relating to travel preferences of a client. Examples of categories of travel preferences in the top-level menu bar 520 may include “Travel Styles” 522 and a catch-all category entitled “Other Preferences” 524. By way of example, a selection of Travel Styles 522 from the top level menu bar 520 may reveal a sub-menu 530 comprising a plurality of styles of travel. These travel styles may include Group Escorted Tours; Custom Private Tours; River Cruising; Small Luxury Cruising; Large Ship Cruising; Expedition Cruising; Sailing and Yachts; Train; Private Jets, etc.

After reviewing the plurality of “Travel Styles” 522 from the sub-level menu 530, the client may select his/her personal travel interests based on travel styles. The client may assign a rating, check a box, or indicate by other means his/her interest. According to one implementation, and as shown in FIG. 5, a “rating” 532 may be assigned to one or more of the plurality of travel styles. Ratings may include, but are not limited to, selections showing a thumbs up (indicating a personal interest of the client), a thumbs down (indicating disinterest), or question mark/neutral sign (indicating potential or ambivalent interest).

With continued reference to FIG. 5, travel preferences may also refer to a variety of “Other Preferences” 524 which may be selected or input by the client. “Other Preferences” may allow the client to input information such as number of vacations desired per year; personal and/or family milestones (birthdays, anniversaries, retirement, etc.); details relating to potential travel companions (family members, children, and friends, including their ages, stages of life, etc.); preferred style of lodging (hotels, boutiques, condos, villas, including preferences for 3-, 4-, or 5-star accommodations); room preferences (standard, deluxe, or suites); and airline preferences (economy or first class).

Returning to FIG. 2, after the client has selected his/her personal travel interests (which may comprise dozens of travel interests), the travel planning platform may now attempt to narrow down the client's top personal travel interests. At step 230, the travel planning platform may organize the client's selected personal travel interests into groupings based on the selections made and/or the ratings assigned by the client in step 220. For example, if the selected personal travel interests are destination-based and the client has rated one or more destinations (i.e., as a “Top Pick”; “Want to Return”; “Unsure”; “Already Visited”; and “Not Interested”), the travel planning platform may narrow the selected travel interests by displaying only the “Top Pick” destinations in a single grouping. These may be displayed in a single list, a scroll-through menu, or any other display means known in the art. It is to be understood that the narrowed grouping of personal travel interests need not be limited to the client's “Top Pick” destinations, but may also include destinations assigned high or moderate ratings by the client (e.g., the “Want to Return” destinations, etc.) Similarly, if the selected personal travel interests are based on travel experiences and/or travel preferences, such interests may also be organized into their respective groupings based on top ratings (i.e., thumbs up), if any, assigned by the client.

At step 240, the client may rank by preference his/her selected personal travel interests, which may have been narrowed and organized into groupings in step 230. Ranking may comprise assigning a numeric value to the selected personal travel interests (e.g., assigning a value between 1-5 to designate the client's top five personal travel interests), manually ordering by preference the selected travel interests (e.g., by clicking and dragging into a top-down order of preference), or other ranking means known in the art. The client may rank his/her selected personal travel interests based on travel destinations, travel experiences, travel preferences, and/or any other category of travel interest offered by the travel planning platform and/or contemplated by one of ordinary skill in the art. Each of the client's rankings may be saved onto the travel planning platform, and may be modified or updated by the client at any time. The step of ranking selected personal travel interests is helpful not only for the client, as it helps the client determine an order of preference for his/her travel interests, but since it may be viewed by the client's travel advisor on his/her advisor portal, it also may be used to develop a travel plan for the client. According to an implementation, the steps of organizing the client's selected personal travel interests (step 230) and ranking the client's selected personal travel interests (step 240) may not be required according to the method 200 of FIG. 2.

Once the client has completed the selections and/or inputs described in connection with steps 220-240 of FIG. 2, the curation process is complete. The client may return to the client portal of the travel planning platform at any time to view, update, and/or modify any of his/her selections. Additionally, completion of the curation process may also enable the client to access and explore a wealth of information relating to the selected travel interests that have been collected and organized by the travel planning platform on the client portal, as described below.

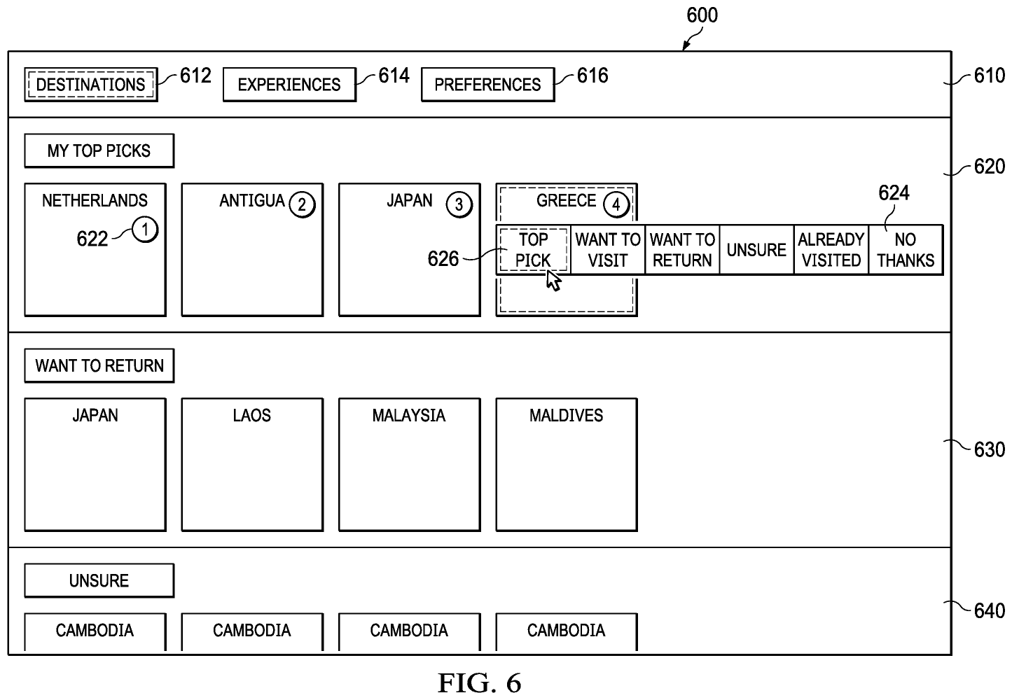

With continued reference to FIG. 2, and with further reference to FIG. 6 (which depicts another exemplary webpage 600 associated with the method 200 described in FIG. 2), the client may now enter the client portal of the travel planning platform. As shown in FIG. 6, webpage 600 of the client portal may display a menu bar 610 comprising at least three tabs for selection by the client: “Destinations” 612; “Experiences” 614; and “Inspirations” 616.

Upon selection of “Destinations” 612 by the client (the selection of “Destinations” 612 indicated by the shading of element 612), at step 250, the webpage 600 may display a plurality of travel destinations, sorted based on the ratings assigned by the client (i.e., “Top Pick” 620; “Want to Return” 630; “Unsure” 640; “Already Visited” (not shown); and “Not Interested” (not shown)). Thus, all of the “Top Pick” selections 620 may be grouped together; the “Want to Return” selections 630 may be grouped together; and so on. The travel planning platform may also display the numeric rankings 622, as applicable, assigned by the client in step 240. The groupings may be arranged in a carousel format, so that the client may scroll through and easily view, modify, and/or update his/her selections within a particular grouping. In an implementation, selections may be updated or modified by, for example, hovering over or clicking a displayed destination to reveal a rating scale 624 featuring the current selection made by the client. By way of example, the shading of “Top Pick” 626 on the rating scale 624 indicates the current rating for that destination (Greece in the example). The client may select a different rating simply by clicking on the desired rating on the rating scale 624.

With continued reference to FIG. 2 and FIG. 6, at step 260, the client may select any one of the displayed plurality of destinations (which have been selected, rated, and/or ranked by the client in steps 220 and 240), and the travel planning platform may generate a robust landing page relating to that selected destination. The robust landing page may include a host of information relating to the selected destination for review by the client. For example, the robust landing page may contain a library of detailed information specifically relating to the selected destination. Detailed information may include data relating to optimal seasons of travel (peak vs. shoulder seasons), seasonal weather patterns and conditions, and unique experiences available at the given destination. Other destination-specific content, such as files relating to local music, links to suggested reading materials, and unique video content files, may also be included for the client's convenience. Additionally, for each selected travel destination, the travel planning platform may also display one or more country pairings applicable to the selected destination for the client's consideration. For example, for a selection travel destination of India, the travel planning platform may propose a pairing with the Maldives Islands (based on the proximity of the countries, the ease with which one may travel between the two, the similarities in cultures, the experiences afforded by the pairings, etc.). According to an implementation, the steps of displaying the personal travel interests of the client (step 250) and selecting a personal travel interest to generate a robust landing page (step 260) may not be required according to the method 200 of FIG. 2.

At step 270, the travel planning platform may automatically generate and/or display, e.g., on each robust landing page, a forecast of the average cost per person per day for various levels of luxury experiences (such as 3-, 4-, and 5-star experiences) for the selected destination. In an implementation, the average cost forecast may also take into consideration any travel experiences and/or travel preferences of the client, as it relates to the selected destination. The client may view these forecasts on his/her user device by accessing the client portal, and then selecting any personal travel interest by destination to view the cost forecast for that destination.

With continued reference to FIG. 6, the client may alternatively select the “Experiences” tab 614 from the menu bar 610 on webpage 600. Upon selection of the “Experiences” tab 614, the travel planning platform may display a plurality of specific experiences available to the client through his/her travel advisor. The plurality of experiences may be organized by various categories. In an implementation, the travel planning platform may organize the display based on specific experiences available in one or more of the “Top Pick” destinations selected by the client. In another implementation, the travel planning platform may account for the general travel experiences selected and/or rated by the client in step 220, and thereby display specific experiences relating to each of those general categories. For example, if the client selected and/or assigned a positive rating to “Nature” in step 220, the travel planning platform may display an array of specific nature-related experiences available throughout the world. Each experience may include its own landing page with detailed information relating to the experience (e.g., locations where the experience may be available, photographic or video content relating to the experience, unique requirements or considerations relating to the experience, etc.). The client may view, select, rate, and otherwise indicate his/her interest in one or more specific experiences displayed by the travel planning platform. Ratings may include, but are not limited to, a thumbs up, thumbs down, or neutral rating (similar to the ratings assigned in the curation stage). In an implementation, when a client positively rates an experience (e.g., with a thumbs up), they essentially create a “wish list” of experiences. This “wish list” of experiences may be stored by the travel planning platform in a manner that is accessible by the client and the travel advisor. Thus, when the client and travel advisor seek to plan a new trip, even five or ten years later, this stored “wish list” of experiences may provide a starting point for the planning process.

With continued reference to FIG. 6, the client may also select the “Inspirations” tab 616 from the menu bar 610 on webpage 600. When the client selects the “Inspirations” tab 616, he/she may be directed to a page displaying unique travel stories, videos, and other original content that are designed to inspire, motivate, and/or raise awareness about various destinations or experiences around the world. Content in the “Inspirations” tab 616 may relate to themes of Discovery; Empowerment; Nature; Culture; and/or Sustainability, for example.

Referring again to FIG. 2, at step 280, having explored the rich content offered in the client portal, the client may now visit with his/her travel advisor to develop a travel plan based on the client's selected and ranked personal travel interests. The travel plan may comprise a multi-trip travel plan, which may map out one or more destinations, may include one or more travel experiences in each of those destinations, and may span one or more years. The multi-trip travel plan may also take into consideration a host of travel preferences of the client, which may have been input into the travel planning platform.

At step 290, the travel advisor may (via the advisor portal of the travel planning platform) generate a multi-trip travel report for the client based on the multi-trip travel plan devised by the travel advisor and the client.

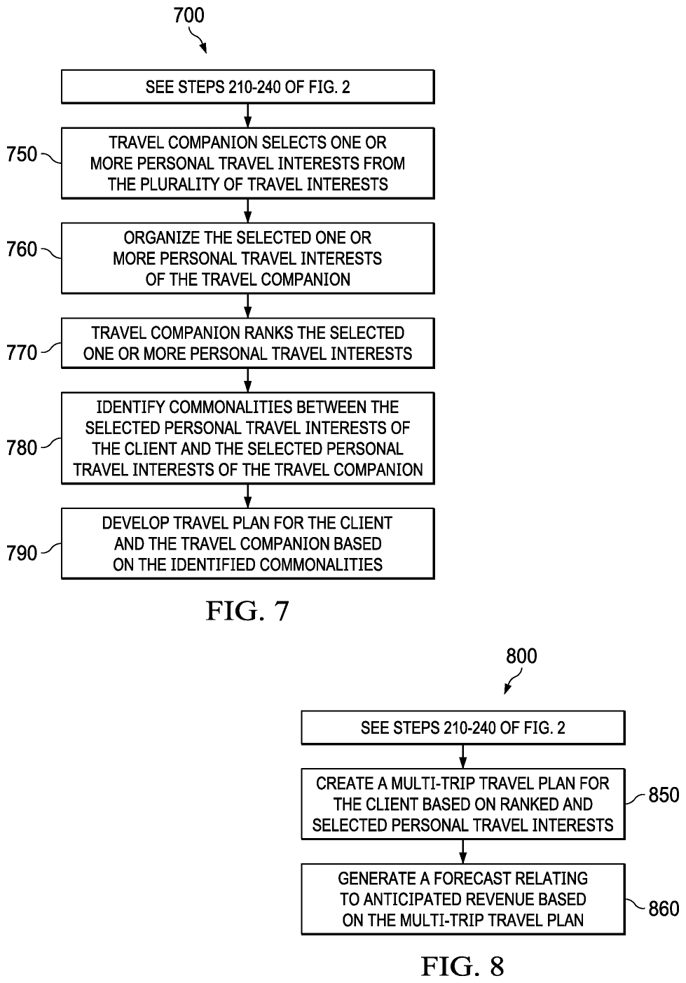

Reference is now made to FIG. 7, which depicts a flow diagram of an implementation of a method 700 of travel planning according to the present disclosure. The method 700 of FIG. 7 may begin in accordance with the method described in steps 210-240 of FIG. 2, namely, the travel planning platform may display a plurality of travel interests; the client may curate his/her interests by selecting one or more personal travel interests from among the plurality of travel interests displayed by the travel planning platform; the travel planning platform may organize the client's selected personal travel interests into groupings based on the selections made by the client; and the client may rank his/her selected personal travel interests.

In accordance with the method 700 of FIG. 7, the client may have the option of inviting one or more prospective travel companions to separately curate their personal travel interests on the travel planning platform. At step 750, a travel companion may curate his/her personal travel interests by selecting one or more personal travel interests from among the plurality of travel interests displayed by the travel planning platform. This step of selecting personal travel interests may proceed in the same or similar manner as that of the client selection process described in step 220 of FIG. 2.

At step 760, the travel planning platform may organize the travel companion's personal travel interests by category based on his/her selections in step 750, in the same or similar manner as that of the client as discussed above in step 230 of FIG. 2.

At step 770, the travel companion may rank his/her selected personal travel interests by preference, in the same or similar manner as that of the client as discussed above in step 240 of FIG. 2. It is to be noted that one or both of the steps of ranking the client's selected personal travel interests and ranking the travel companion's selected personal travel interests may be optional to the method 700 shown and described in connection with FIG. 7.

Next, at step 780, the travel planning platform may automatically identify commonalities between the selected personal travel interests of the client and the selected personal travel interests of the travel companion. For example, the travel planning platform may generate and display a side-by side comparison that visually captures the common personal travel interests of the client and his/her travel companion. The comparison may be sorted based on highest to lowest level of commonality. The comparison may be presented in a chart format and may show, for example, common travel destinations of interest (including each traveler's rating and/or ranking, if applicable, for such destination), common travel experiences of interest (including each traveler's rating and/or ranking, if applicable, for such experience), and common travel preferences of the client and his/her travel companion. The travel planning platform may further generate reports depicting all the travel interests of the travel companion, regardless of shared commonality with the client's travel interests.

In another implementation, the travel planning platform may curate the travel interests of multiple travel companions, thereby automatically identifying commonalities between the selected travel interests of the client and the selected travel interests of the multiple travel companions. For a client opting to travel with one or more travel companions, the foregoing information may allow the client to quickly and efficiently narrow his/her choice of travel destination based on the common interests of all travelers.

At step 790, the client may now visit with his/her travel advisor to develop a travel plan based on the common selected personal travel interests of the client and his/her travel companion(s). The travel plan may comprise a multi-trip travel plan for the client and one or more of his/her travel companions, which may map out one or more destinations, may include one or more travel experiences in each of those destinations, and may span one or more years. By way of example, the client's travel plan may include separate trips with different travel companions or groups of travel companions (i.e., one or more trips with a spouse, family members, children, friends, etc.). The multi-trip travel plan may also take into consideration a host of travel preferences of the client and his/her travel companion(s), which may have been input into the travel planning platform.

Reference is now made to FIG. 8, which depicts a flow diagram of an implementation of a method 800 for forecasting revenue in the travel planning industry according to the present disclosure. The method 800 of FIG. 8 may begin in accordance with the method described in steps 210-240 of FIG. 2, wherein the travel planning platform may display a plurality of travel interests; the client may curate his/her interests by selecting one or more personal travel interests from among the plurality of travel interests displayed by the travel planning platform; the travel planning platform may organize the client's selected personal travel interests into groupings based on the selections made by the client; and the client may rank his/her selected personal travel interests.

In accordance with the method 800 of FIG. 8, once the client has completed the curation process (by selecting, rating, and/or ranking personal travel interests), the travel advisor may review any of the client's selections (including selections relating to travel destinations, travel experiences, travel preferences, one or more travel companions' selections, and the like) via an advisor portal on the travel planning platform. The travel planning platform may generate for the travel advisor an analysis of the personal interests of the client and his/her travel companions. This analysis may include, for example, overall interest (high or low interest) in a particular top-level or sub-level destination or experience category. At step 850, the travel advisor may meet with the client and develop a travel plan based on the selected and/or ranked personal travel interests of the client. The travel plan may comprise a multi-trip travel plan, which may include one or more destinations (including the length of stay at each of those destinations), may include one or more travel experiences in each of those destinations, and may span one or more years. The multi-trip travel plan may also take into consideration a host of travel preferences of the client, which may have been input into the travel planning platform.

At step 860, the travel planning platform may generate a client-based forecast relating to the revenue anticipated based on the multi-trip travel plan of the client. In other words, because a multi-trip travel plan (which may span one or more years) has been developed, the travel advisor may forecast anticipated revenue, not just for the short-term, but for longer periods of time, depending on the number of trips set forth in the multi-trip travel plan. According to an implementation, the client-based forecast may comprise the anticipated lifetime revenue to the travel advisor associated with the given client. The travel advisor may view the client-based forecast on the advisor device 160 at any time by accessing the advisor portal 130 on the travel planning platform 110.

In another implementation, the travel planning platform may generate an overall forecast relating to the revenue anticipated based on a plurality of multi-trip travel plans for a plurality of clients. In other words, the overall forecast may quantify the cumulative value of revenue anticipated for a travel advisor's entire portfolio of clients. The overall forecast may be viewed on the advisor device 160 and accessed by the travel advisor through the advisor portal 130 of the travel planning platform 110.

In yet another implementation, the travel planning platform may utilize the data relating to the selected travel interests entered into the travel planning platform by a plurality of clients to generate statistics relating to overall travel interests and trends. For example, the travel planning platform may display (in pictorial or graph form) the percentage of clients interested in the various travel destinations, travel experiences, and/or travel preferences. With this data, and the ability to monitor travel interest trends at any given point in time, a travel advisor may more narrowly tailor his/her services and advising strategies for clients (i.e., by creating and providing packages aligned with overall client interest, by focusing the time and energy on travel destinations and experiences that have garnered the most client interest, etc.).

While certain general framework components and functionality have been described herein, the present disclosure is not intended to be so limited. As understood in the art, various components and functionality may be integrated with and/or modified in the system without departing from the spirit and scope of the present disclosure.

It is to be understood the implementations are not limited to particular systems or processes described which may, of course, vary. It is also to be understood that the terminology used herein is for the purpose of describing particular implementations only, and is not intended to be limiting. As used in this specification, the singular forms “a”, “an” and “the” include plural referents unless the content clearly indicates otherwise.

Although the present disclosure has been described in detail, it should be understood that various changes, substitutions and alterations may be made herein without departing from the spirit and scope of the disclosure as defined by the appended claims. Moreover, the scope of the present application is not intended to be limited to the particular implementations of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding implementations described herein may be utilized according to the present disclosure. Accordingly, the appended claims are intended to include within their scope such processes, machines, manufacture, compositions of matter, means, methods, or steps.

1. A method of travel planning, comprising the steps of:
displaying a plurality of travel interests on a user device associated with a travel planning platform;
receiving a first input to the travel planning platform, the first input indicating one or more personal travel interests of a client, the one or more personal travel interests selected by the client from the plurality of travel interests; and
the travel planning platform automatically forecasting average cost per person per day based on the first input for one or more of three-, four-, or five-star experiences.

2. The method of claim 1, wherein the plurality of travel interests comprises:
a plurality of travel destinations.

3. The method of claim 2, further comprising the step of:
displaying, on the user device, an information page relating to at least one of the plurality of travel destinations, the information page displaying information comprising at least one of the following relating to the at least one of the plurality of travel destinations: optimal seasons of travel, seasonal weather patterns, unique experiences, music content, reading materials, and video content.

4. The method of claim 1, wherein the plurality of travel interests comprises:
a plurality of travel activities.

5. The method of claim 1, further comprising the step of:
the travel planning platform generating one or more suggested pairings for at least one of the selected personal travel interests.

6. The method of claim 1, further comprising the step of:
receiving a second input to the travel planning platform, the second input indicating a ranking by preference of the selected personal travel interests of the client.

7. The method of claim 6, further comprising the step of:
the travel planning platform organizing the plurality of travel interests based on the first input and the second input.

8. The method of claim 7, further comprising the step of:
displaying the organized plurality of travel interests on the user device.

9. The method of claim 6, further comprising the step of:
developing a travel plan for the client based on the first input and the second input.

10. The method of claim 9, wherein the step of developing comprises:
developing a multi-trip travel plan for the client based on the first input and the second input.

11. The method of claim 10, further comprising the step of:
generating a multi-trip travel report for the client based on the multi-trip travel plan.

12. The method of claim 6, further comprising the step of:
receiving a third input to the travel planning platform, the third input indicating one or more travel preferences of the client.

13. The method of claim 12, further comprising the step of:
developing a travel plan for the client based on the first input, the second input, and the third input.

14. The method of claim 6, further comprising the step of:
receiving a fourth input to the travel planning platform, the fourth input indicating one or more personal travel interests of a travel companion of the client, the one or more personal travel interests selected by the travel companion from the plurality of travel interests.

15. The method of claim 14, further comprising the step of:
the travel planning platform automatically identifying one or more commonalities between the first input and the fourth input.

16. The method of claim 15, further comprising the step of:
developing a travel plan for the client and the travel companion based on the one or more commonalities between the first input and the fourth input.

17. The method of claim 14, further comprising the step of:
receiving a fifth input to the travel planning platform, the fifth input indicating a ranking by preference of the selected one or more personal travel interests of the travel companion.

18. The method of claim 17, further comprising the step of:
the travel platform automatically identifying one or more commonalities between the second input and the fifth input.

19. The method of claim 12, further comprising the step of:
receiving a sixth input to the travel planning platform, the sixth input indicating one or more travel preferences of a travel companion of the client.

20. The method of claim 19, further comprising the step of:
the travel platform automatically generating a comparison between the third input and the sixth input.

21. The method of claim 10, further comprising the step of:
the travel planning platform generating a client-based forecast for a travel advisor, the client-based forecast relating to a first travel revenue anticipated based on the multi-trip travel plan for the client.

22. The method of claim 21, wherein the generated client-based forecast anticipates revenue over multiple years.

23. The method of claim 21, further comprising the step of:
the travel planning platform generating an overall forecast for the travel advisor, the overall forecast relating to a second travel revenue anticipated based on a plurality of multi-trip travel plans for a plurality of clients.

24. The method of claim 23, further comprising the step of:
the travel planning platform generating a report showing trends relating to travel interests based on the selected personal travel interests of the plurality of clients.

25. The method of claim 24, wherein the generated report showing trends relating to travel interests is based on selected travel destinations.

26. The method of claim 24, wherein the generated report showing trends relating to travel interests is based on selected travel activities.
